(19) United States
(12) Patent Application Publication
(10) Pub. No.: US 2002/0068633 A1
(43) Pub. Date: Jun. 6, 2002

(54) Real-time odds-based gaming

(76) Inventor: Roger L. Schlaifer, Atlanta, GA (US)

Correspondence Address: GARDNER GROFF & MEHRMAN, P.C., PAPER MILL VILLAGE, BUILDING 23, 600 VILLAGE TRACE, SUITE 300, MARIETTA, GA, 30067, US

(21) Appl. No.: 10/008,804

(22) Filed: Dec. 3, 2001

Related U.S. Application Data
(60) Provisional application No. 60/250,424, filed on Dec. 1, 2000.

(51) Int. Cl. G06F 17/00

(52) U.S. Cl. 463/43

(57) ABSTRACT

A controller 12 communicates with an officiator 14, a database 16, and user interfaces 18 for players watching a sports event. The officiator 14 selects and enters into the controller 12 outcomes choices 22 for a game play, the controller determines payout odds 27 for the outcome choices based on information retrieved from the database 22, the players select a predicted outcome 30 and wager an amount 32 on it, the officiator 14 enters the actual outcome 34, and the controller applies credits or debits to players score amounts 28 based on the odds payouts and wagered amounts. The user interfaces 18 can be PC's, PDA's, cell phones, etc., for a web site version, keypads, joysticks, and/or touch screens for a home or restaurant version, or keypads on pedestals or the like for a television show.

### CROSS-REFERENCE TO RELATED APPLICATION

This application claims the priority benefit of U.S. Provisional Application No. 60/250,424 filed on Dec. 1, 2000, which is hereby incorporated by reference in its entirety.

### TECHNICAL FIELD

This invention relates generally to gaming systems for wagering on the outcome of events and, more particularly in an exemplary embodiment, to such a system for wagering amounts on the outcome of each play of a sporting event.

### BACKGROUND OF THE INVENTION

Many people around the world routinely entertain themselves by watching or attending sporting events. In this country, popular sports include football, baseball, basketball, hockey, and so forth, including professional, collegiate, and other leagues. In some other countries, popular sports include soccer, rugby, cricket, and others.

But for many sports enthusiasts, routinely watching game after game has become stale due to the number of cable stations delivering 24-hour sports programming and the wide variety of entertainment options available. In an apparent attempt to enhance the sports spectator experience, a “PREDICT THE PLAY™” sports web site has been announced. This web site purports to, when launched, allow game viewers to predict the next play in a game and receive points or point deductions for correctly or incorrectly predicting the outcome. While it appears that this concept would add some excitement, it nevertheless seems to offer only a nominally increased entertainment value.

Accordingly, a need remains in the art for a system for enhancing the spectator experience of sporting events. Also, such a system is desirable that provides a play-along feature to better engage the spectator in the flow of the game. Furthermore, there is a need for such a system that can be adapted for use in a wide variety of applications. It is to the provision of such a system that the present invention is primarily directed.

### SUMMARY OF THE INVENTION

Briefly described, in an exemplary form the present invention comprises a real-time odds-based gaming system and method that permits players to watch a sports or other event and wager on the outcome of plays or other segments of the event as it progresses. The exemplary system includes a controller that communicates with an officiator, a database, and user interfaces for players watching the event. The officiator is a person or computer that selects and enters into the controller outcome choices for a play. The controller is a computer that determines payout odds for the outcome choices based on data retrieved from the database, and displays the outcome choices and the payout odds to the players on their user interfaces. Using their user interfaces, the players can select a predicted outcome from the outcome choices and wager an amount on their predicted outcome. The officiator enters the actual outcome of the play into the controller, and the controller determines and applies credits or debits to players score amounts based on the actual outcome, the odds payouts and the wagered amounts.

The user interfaces can be PC's, PDA's, cell phones, etc., for a web site version, keypads, joysticks, and/or touch screens for a home or restaurant version, or keypads on pedestals or the like for a television show version. Also, the user interfaces can communicate with the controller over the Internet, wires, wireless systems, or otherwise.

The outcome choices displayed to the players are pre-selected to be relevant to the current game situation. Thus, as the sports event progresses and the game situation changes, say from first down and ten yards-to-go to second down and one yard-to-go, the outcome choices can be tailored to include the now likely (or unlikely) play outcomes. In this way, the pre-selection of the outcome choices provides for a more interesting player experience than known systems that permit only picking from a constant list of outcomes.

The database retrievably stores information relating to the event, such as probabilities or payout odds for the play outcomes occurring, other statistical data relating to the play outcomes, trivia information relating to the play outcomes, sports event players, locations, weather, etc. Thus, the players can be presented with not only the outcome choices, but also with payout odds for wagering on each of the outcome choices, unlike known systems. This adds to the strategic nature of the gaming system and method, and enhances the entertainment and educational value to the players.

### BRIEF DESCRIPTION OF THE DRAWING FIGURES

FIG. 1 is a block diagram of a real-time odds-based gaming system according to a first exemplary embodiment of the invention.

FIG. 2 is a flow diagram for real-time odds-based gaming according to an exemplary method of the invention.

FIG. 3 is a sequence of exemplary graphics displayed on the user interfaces and showing the operation of the gaming system or method of FIGS. 1 or 2.

FIG. 4 is a block diagram of a real-time odds-based gaming system according to a second exemplary embodiment of the invention.

FIG. 5 is a block diagram of a real-time odds-based gaming system according to a third exemplary embodiment of the invention.

### DETAILED DESCRIPTION OF THE EXEMPLARY EMBODIMENTS

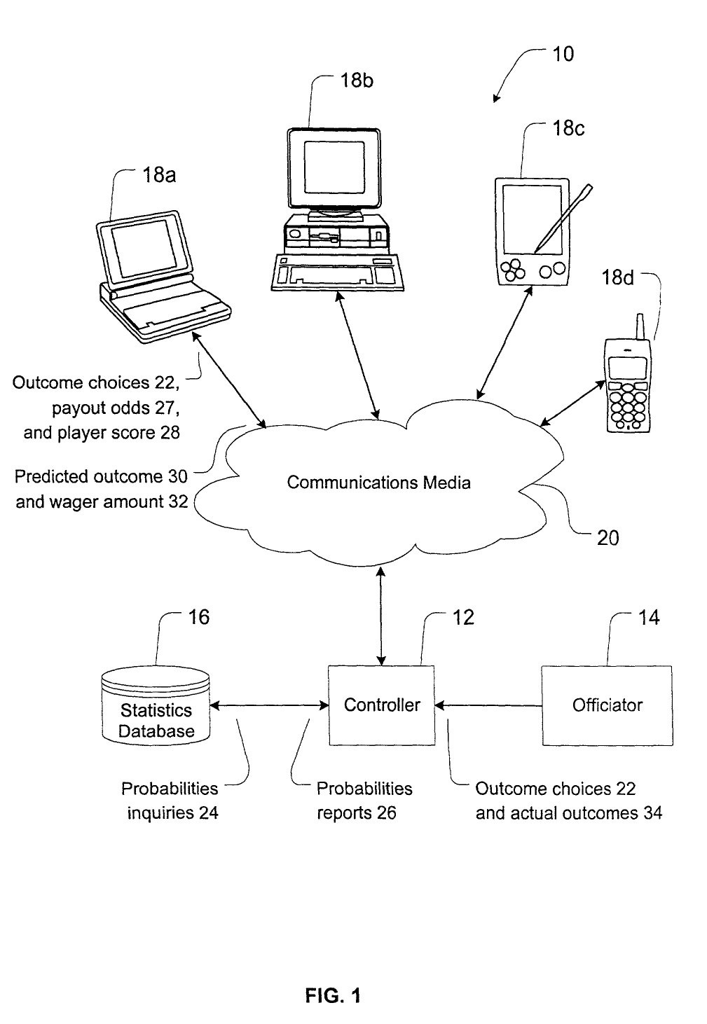

Referring now to the drawing figures, wherein like reference numerals represent like parts throughout the several views, FIG. 1 shows a real-time odds-based gaming system 10 according to a first exemplary embodiment of the present invention. The system 10 can be used by a number of players to play an odds-based wagering game in real-time along with an actual event such as a sports game. The players can use the system 10 to predict and wager on the outcome of discrete segments of the actual game, and then receive credits or debits determined by the actual outcome of the game segment and the payout odds for that outcome. In this way, the wagering players can enjoy the strategy of matching wits with and outguessing the coaches and/or actual game players. Accordingly, the system 10 provides an enhanced spectator experience to the players over merely watching or listening to the game and over other known gaming systems.

The system 10 can be configured to allow the players to wager on game segments such as football plays, possessions, quarters, and/or complete games; baseball pitches, innings, and/or complete games; basketball possessions, quarters, and/or complete games; hockey possessions, periods, and/or complete games; golf swings, holes, rounds, and/or tournaments; motor sports laps, lead changes, maneuvers, or race finishes; tennis serves, returns, volleys, games, sets, and/or matches; and other segments of other team or individual sports games such as lacrosse, soccer, rugby, badminton, bowling, cricket, jai alai, wrestling, bicycle, horse, or dog racing, and so on. Alternatively, the system 10 can be configured to permit wagering on the outcome of other events such as the stock market, weather, traffic, elections, or any other event with multiple possible outcomes and determinable odds of those outcomes occurring.

It will be understood that the event can be live, played-back from a recording, animated based on an actual game, a fantasy game animated with real players, a fictional game using fictional players, or a combination thereof. Thus, “real-time” as used herein means approximately concurrently with the player apprehending the event. Also, the system 10 can be configured for use with a menu of all ongoing games, a predetermined game of the week, or otherwise, and/or for use with more than one sports event simultaneously.

The players can be spectators present at the event or remotely viewing or listening to the event via a television, computer, projection screen, radio, or other device. Additionally, the players can wager amounts of points, money (where legal), chips having values, or other wagering units. Furthermore, the players can win prizes, game credits, or other rewards based on their accumulating these amounts.

Turning now to the components of the system 10, it includes a controller 12 that communicates with an officiator 14, with a database 16, and with one or more user interfaces. The user interfaces can be provided by laptop computers 18a, desktop computers 18b, personal digital assistants 18c, web phones 18d, or other portable or normally stationary communication devices (collectively the “user interfaces 18”). Where the user interfaces 18 are laptop computers, desktop computers, or other devices with good viewing capabilities, the players can use the interfaces for input and output purposes. On the other hand, where the user interfaces 18 are personal digital assistants 18c, web phones 18d, or other devices with relatively small viewing screens, the players can watch the actual game on a television or other device and use the interfaces only as inputting devices, if so desired.

The controller 12 communicates with the user interfaces 18 through a communications media 20 such as the Internet, telephone lines, cable television cables, other metal or fiber-optic cables, wireless systems such as radio, microwave, or another frequency system, satellite systems, and/or otherwise. Thus, the controller 12 is a programmed computer that, in this embodiment, is configured as a web server storing a web site with graphics and text for interactively playing the game. Accordingly, the players can play the game by accessing the controller/web server via the Internet to bring up the web site. In this way, the players can play the game at home, at work, in airports, in sports bars, in their cars, or elsewhere.

The officiator 14 is a person who enters information via an input device (e.g., a keyboard or microphone) into the controller or who indicates to another person what information should be so entered. Thus, the officiator 14 can be an actual game official with a portable input device for inputting his calls as he makes them, an official game scorer who receives the calls from the game officials, a person beside the official game scorer who has access to the game official's calls, someone observing the event who is at the event or watching it from somewhere else, or another person. Alternatively, the officiator 14 can be provided by a computer programmed to determine what information should be entered into the controller based on historical data or randomly.

The database 16 is stored on a computer-readable storage device and includes a compilation of information such as statistics, sports records, and/or other historical data that is configured for retrieving the information in response to an inquiry from the controller 12. The information in the database 16 can include statistics for an entire team, a group of players (e.g., an offensive or defensive unit), and/or individual game players, such as typical game statistics relative to all or to only specific opponents, locations, weather conditions, and so forth. The database 16 can be updated regularly with the latest information to stay reasonably current, including updates from ongoing games if so desired. One such known database 16 can be licensed or purchased from the Elias Sports Bureau, Inc. of New York, N.Y.

The officiator 14 and the database 16 can be separate and remote from the controller 12 or integral with it, and remote from or on site at the event. Where the officiator 14 and the database 16 are remote from the controller 12, they can be configured to communicate with the controller through a similar communications media. Where the officiator 14 and the database 16 are local to the controller 12, they can be hardwired directly to it, if so desired.

In order to facilitate cooperation between the database 16 and the controller 12, some or all of the relevant statistics, sports records, and/or other historical data can be represented in the database as the probabilities of events occurring. These probabilities can be in the form of percentages, fractions, ratios, or otherwise as may be desired. As used herein, the “probability” of an event occurring is the likelihood (i.e., the chance) of that event occurring, and the “payout odds” for that event is the probability that the event will not occur (although additional factors may be included in the payout odds, as described below). For example, if the likelihood of an outcome is one in four then the probability of that outcome is one fourth (or 0.25), and the payout odds for that outcome is three to one—because three times out of four it probably won't happen. In this way, lower likelihood outcomes will pay back a higher return, thereby enhancing the fun of wagering on the game action.

Accordingly, some modifications to the aforementioned database may be beneficial. For example, fractions or ratios can be converted to percentages (or vice versa, whichever form is selected for the odds). Also, new fields can be created for probabilities that have not been compiled but that are determinable from other information fields in the database. These and any other desired adaptations can be readily made by a person of ordinary skill in the computer programming art.

It will be understood that the information in the database can be in other forms than probability percentages, fractions, or ratios, and that these are described for illustrative purposes only. For example, the payout odds can be stored directly in the database. Also, the database can store non-probabilistic statistics such as a particular player's career number of rushing first downs on third down and his career number of third down rushing attempts, from which his career third down conversion rate can be determined. As another example, the database can be configured to retrievably store textual (as well as numeric) information such as the names of players, coaches, stadiums, etc., with trivia about them such as the colleges attended by players, their hometowns, teams previously coached by a particular coach, stadium capacities, championship won by a player, and so on. This information can be used for wagering on random bonus questions, on tie-breakers, or in other gaming situations.

The programming of the controller 12 will now be described. The controller 12 is programmed to receive a designation of outcome choices 22 from the officiator 14. The officiator 14 monitors the actual game action and, based on the then-current game situation, selects outcome choices 22 that are relevant and/or interesting. For example, in an American rules football game when the game situation is third down and one yard-to-go on the offense's 29-yard-line, the officiator 14 might designate as the outcome choices 22 a run for a first down (a seemingly likely scenario), a long pass over fifty yards (probably a less likely but nevertheless interesting play call), and a fumble (somewhat of a wildcard prediction, but more relevant when considering the offensive backs on the field). These outcome choices 22 are more closely tailored to the ongoing game action, and therefore provide a more fun gaming experience than wagering on randomly presented outcomes.

The controller 12 can be programmed to receive any outcome choice 22, as the possible choices are limited only by the type of game and whether the information is stored in and retrievable from the database. Accordingly, the outcomes just mentioned are for illustration only, and many others are possible. For example, continuing with the American rules football version, some of the possible outcomes for the next play can be a pass, run, gain, loss, first down, touchdown, or a combination of these. Special teams plays can be included with the outcome choices 22 including punts inside the twenty-yard-line, kickoffs returned for a touchdown, field goals made or missed, and so on. Additionally or alternatively, the outcome choices 22 can include a list of sports players who might be involved in the play, so the wagering player can choose who will run the ball or catch a pass. Furthermore, the controller 12 can be programmed with the outcome choices 22 characterized as offensive or defensive, with defensive outcomes including whether there will be an interception, quarterback sack, fumble, and/or blitz on the play. Moreover, the outcomes choices 22 can additionally include factors such as the then-current weather, the stadium where the game is played, game totals (winners, scores, total yards, etc.), and so forth.

With all of these outcome choices 22 of varying levels of specificity, the payout odds will be higher for more specific outcomes than for less specific ones. Thus, the payout odds for correctly choosing that the play will be a pass and also choosing the correct receiver will be higher than for merely correctly choosing the play will be a pass.

Also, because the system 10 is played in real-time and uses probabilistic information in the database, on every play the probabilities and payout odds for the outcomes can be different. For example, the probabilities and payout odds for a run for a first down will change from one play to the next depending on the changing game conditions such as different running backs, downs and yards-to-go, field position, etc., thereby making the game more realistic and enjoyable.

As mentioned above, the system 10 can be configured for wagering on any type of sporting or other event. The possible outcome choices 22 for all the possible events are too numerous for listing herein. Those skilled in the art, however, will understand that the typical outcomes of game action in those many other possible events can be readily substituted for those listed above for football to produce a similarly enjoyable gaming experience. For example, for baseball, the outcomes can include whether the next pitch will be a fastball, the batter will get a hit, the batter will hit a home run, a base-runner will safely steal, and so on. Also, the probabilities can be more specifically based on the particular pitcher, batter, inning, count, etc., if so desired.

Continuing with the programming of the controller 12, it sends inquiries to the database 16, for example, inquiries 24 of the probabilities of the occurrence of the designated outcome choices 22. The database 16 then retrieves and returns an odds report 26 to the controller 12. Where the database 16 includes the probabilities of the occurrence of the designated outcome choices 22, the odds report 26 comprises these probabilities. On the other hand, where the database 16 has statistical data but not the desired probabilities, the odds report 26 comprises this data. Using this statistical data, the probabilities are determined by the controller 12 or by another computer in communication with the database 16.

The controller is 12 programmed to then, based on the probabilities, determine obtain payout odds 27 for each of the outcomes choices 22. The payout odds 27 can be determined using conventional statistical techniques. For example, for a probability of “X” times in “Y,” the payout odds can be determined as “Y-X : X.” Thus, for a probability of one in four (0.25), by plugging these numbers into the above formula the payout odds are determined to be (4-1) 1, that is, 3:1. Alternatively, as mentioned above, the database 14 can store the payout odds 27 themselves so that the controller 12 does not need to determine these, or the data can be stored in other forms with the controller programmed so manipulate the data accordingly to arrive at the payout odds.

Where desired, the controller 12 can be programmed to include an adjustment to the payout odds 27 based on additional factors to increase or decrease the payout odds. For example, the payout odds 27 can be increased for certain outcome choices 22 to provide an increased incentive for players to choose to wager on that particular outcome. This can be done by randomly or regularly doubling the initially determined payout odds for an only occasional outcome such as a fumble and tripling them for a more unusual outcome such as a kickoff return for a touchdown. Alternatively, any odds payout over a predetermined value or plan deviation, say of 5:1, can be multiplied by factor of two, three, or other number. In this way, a player who is behind can make up ground quickly and is less likely to lose interest in continuing to play the game system.

The controller is 12 programmed to then send the outcome choices 22 and the odds payouts 27 to the user interfaces 18. Based on this information, the players then input into the user interfaces 18 their predicted outcomes 30 and wager amounts 32. Then the user interfaces 18 send these to the controller 12.

The controller 12 is further programmed to receive actual outcomes 34 of the game segment from the officiator 14. After the play or other game segment transpires, the officiator 14 inputs the actual outcome 34 into the controller 12. The controller 12 is programmed to then compare the predicted outcomes 30 with the actual outcome 34 and, based on the payout odds 27 and whether the players' predicted outcome was correct, determine a credit or debit amount to the players' scores 28. The controller 12 then updates the players' scores 28 accordingly, and sends the updated scores to the respective players' user interfaces 18. Where the actual outcome 34 was a score or change of possession, the controller 12 also sends a game score update to the user interfaces 18. The system 10 then repeats the process for the next play, with the officiator 14 selecting new outcome choices based on the now-changed game situation.

The above description details the selection, configuration, interrelationship, and operation of the system components during game play. Before play begins, the controller 12 is programmed to initialize the player scores 28. For example, the player scores can be initialized at a predetermined amount (e.g., 100 points or $500 in cash or chips) that they can parlay into tens of thousands (or more) of dollars worth of cash or prizes, or that they can lose all of. Also, the controller 12 can be programmed to collect a fee from the player's credit card accounts or otherwise, with the fee amount based on a fixed amount of time (e.g., one hour), number of plays (e.g., 50), or otherwise. The controller 12 is further programmed to designate one (or more) player as a winner based on who tallies the highest player score, who scores a predetermined amount within a set time, or otherwise.

A number of variations and options can be included in the gaming system 10 and/or in the below-described gaming method. In one alternative embodiment, the controller 12 randomly or regularly queries the database 14 for trivia information such as questions and answers relating to the next or the preceding play. For example, the trivia information can include the probability of a particular outcome or of a particular outcome repeating itself. The controller 12 then sends the trivia question to the user interfaces 18, compares the players returned answers to the correct answer from the database 14, and award bonus or tie-breaker amounts to the players who answered correctly. This feature provides further entertainment to the players, as sports fans sometimes ask the question “what are the odds of that happening” upon the occurrence of an unusual play.

In another embodiment, the controller 12 is programmed to send additional outcome choices to the user interfaces 18 randomly or in response to a prompt from the players' user interfaces. These additional outcome choices can be “long-shot” outcomes that, when correctly chosen by the players, award exaggerated amounts to the players' scores to permit them to catch up when trailing in the game. These long-shot outcomes can include calling before the game starts (or before some other predetermined point before the game is over) a total number of passes or touchdowns, the final score or spread, etc.

In yet another embodiment of the invention, the controller 12 can be programmed to update the database 14 with the actual outcomes 34 as they are received from the officiator 16. In this way, the database 14 is always current so that the basis for the probabilities retrieved by the controller 12 for one play will include the outcome of the previous play.

In still another embodiment of the invention, the controller 12 can be programmed with fixed payout odds (stored in the database 16 or in another database in communication with the controller) and a menu of possible outcome choices. The designated outcome choices are selected from the menu and matched to the fixed payout odds by the controller or the officiator based on the then-current game situation. For example, the controller could present the players with payout odds of 1:2, 1:1, 5:1, 10:1, and 50:1. If a team had a first down on the fifty-yard line, the 50:1 outcome option might be matched with a long pass into the end zone. Also, the even option might be matched with a hand-off from the quarterback to the running back proceeding up the middle of the field. On the other hand, if a team had a first and goal at the opponent's nine-yard line, the 50:1 outcome option might be matched with a quarterback sneak. Thus, the payout odds presented to the players would not change, but the outcome choices would.

Alternatively, the controller 12 can be programmed to randomly or regularly select the payout odds from a menu of available payout odds, for example ranging from 1:1 to 50:1, so that the payout odds would change from play to play. The controller 12 would then match the outcome choices to the selected payouts odds randomly, based on probabilistic data retrieved from the database or from another data storage device in communication with the controller, or otherwise. As another alternative, instead of fixed odds payouts, the players could be presented with fixed points options of, for instance, 5, 10, 50, 100, and 500 points. With these alternative embodiments, a commercially available database can be used with minimal modifications, or the system can be provided without a database, while still providing the desired gaming experience.

The determination of which outcome choices to match with which odds payouts can be programmed into the controller or performed manually by the officiator, a game host, or another person. The determination can be made randomly or based on historical data stored in a storage device associated with the computer, in the database, or elsewhere.

A number of other alternative embodiments can be provided with different wagering and outcome choice features. In one of these, the controller 12 is programmed to provide a pull-down menu of outcome choices 22 for display on the user interfaces 18 and from which the players can choose. In another of these embodiments, the controller 12 can be programmed to provide an outcome choice of “none of the above” (or “all of the above” or a combination or the outcome choices) so that every play results in scoring for the players.

In another embodiment, the controller 12 is programmed to receive the players predicted outcomes 30 during the play. This can be a beneficial option for sports such as basketball, hockey, and soccer, which have fewer discrete game segments than football. Using basketball as an example, the controller can be programmed to retrieve and/or determine payout odds, send to the user interfaces the outcome choices, and receive the returned predicted outcomes of a made three-point shot, a rebound by a specified player, a charge, a blocked shot, and so on, depending on the rapidly changing game situation.

In a further embodiment, the controller 12 is programmed to permit the players to wager on data relating to a play after the completion of the play. In addition to the “what are the odds of that happening” questions mentioned above, the players can wager on other odds-related or on non-odds-related data such as last time a player made the same play.

Other embodiments include programming the controller 12 to permit wagering on whether the actual outcome will break a record. Still other embodiments include permitting wagering on whether a particular sequence of plays will occur, perhaps consecutively, or whether another player predicted the correct outcome (including in games where the players alternate who predicts the next play).

In another embodiment the controller 12 is programmed to receive a feed of the sports games being wagered on, bundle this signal with outcome choices and payout odds, and send all of these to the user interfaces. In this way the players can watch the sports game on the same screen that shows the outcome choices and payout odds overlaid in a box or portion of the user interface screen.

Another embodiment provides for single player use, with the controller 12 programmed to select predicted outcomes and receive score amounts. In this way, one player can play against the computer to provide an entertaining competition.

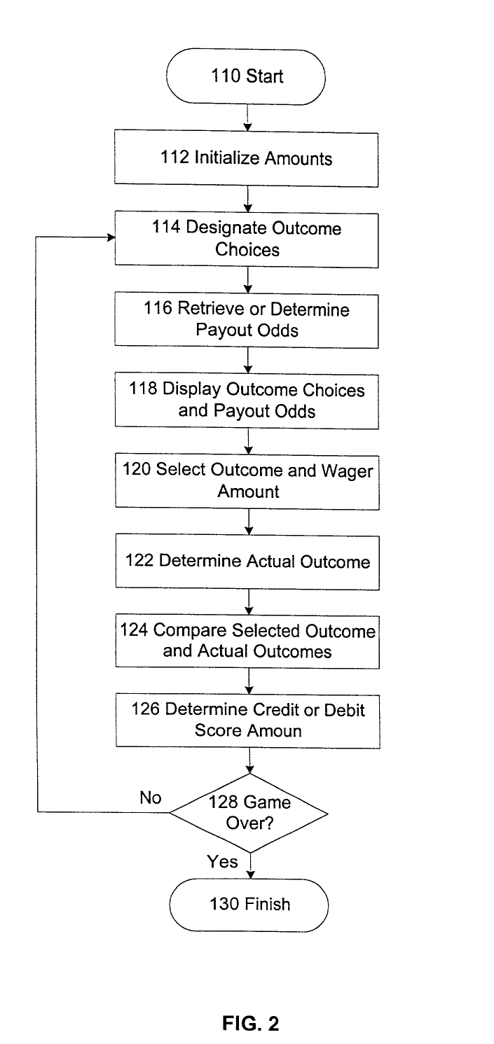

Referring now to FIG. 2, the present invention includes a real-time odds-based gaming method 100. The method 100 can be used with the above-described system 10, with the below-described systems 200 or 300, or with other gaming systems, to provide an enhanced experience for players watching a sports game. Also, the method 100 can be carried out by a web site, a home or restaurant game, a television show, or otherwise.

At 110, the players join the game by logging onto the system, activating a “start” mechanism, or otherwise joining the game, and selecting the particular game or other event that they wish to wager on. At 112, the players enter identification information and are presented with options such as receiving a display of their scoring history and continuing to track their scoring history. The player score amounts are then initialized at an amount of points, chips, money, etc.

At 114, outcome choices for a game play are designated, randomly or based on the then-current game situation, by, for example, an officiator. Then at 116, payout odds for the designated outcome choices are retrieved or determined. For example, the payout odds can be retrieved directly from a database, or they can be determined based on data retrieved from a database or elsewhere. Additionally, the payout odds can include adjustments to increase or decrease the amounts returned to the players to enhance to fun of the game.

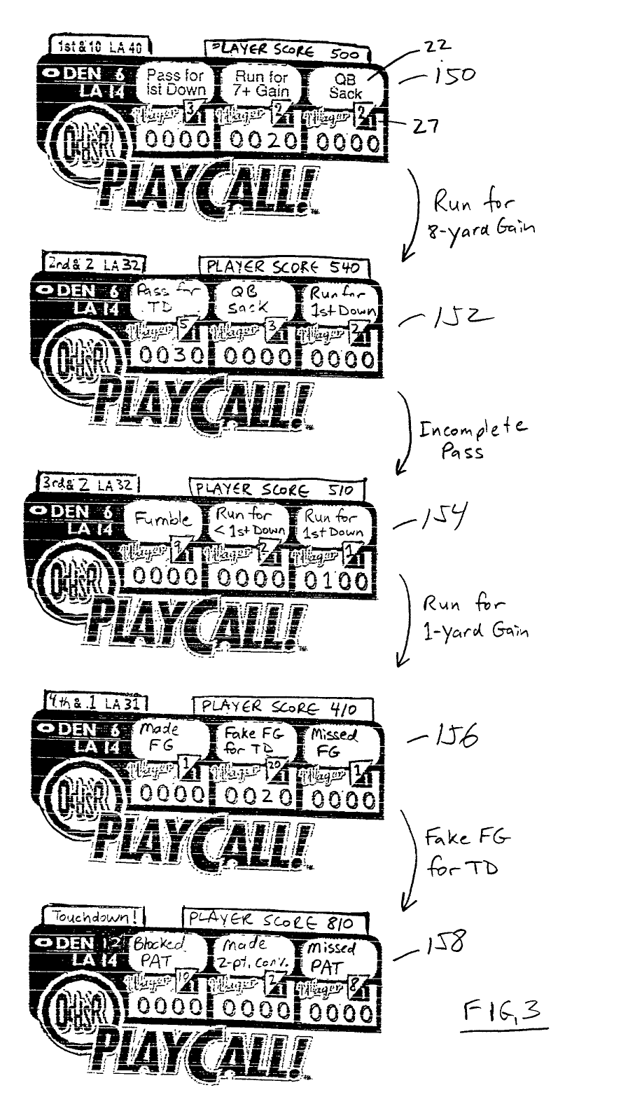

Next, at 118, the designated outcome choices and the corresponding payout odds are displayed (visually, audibly, or otherwise) to the players via their user respective interfaces (see also FIG. 3). At 120, the players select a predicted outcome from the outcome choices, and enter a wager amount 32 on their predicted outcome.

Then at 122, the actual outcome of the play is determined by, for example, an officiator. At 124, the players' predicted outcomes are compared against the actual outcome. Then at 126 the players scores are credited or debited an amount determined by whether their predicted outcomes where correct and, if correct, then also by on the payout odds.

Then at 128, if a predetermined criteria for the completion of the game (based on player scores or otherwise) has not been met, the gaming method returns to step 114 and repeats from there. If the game is determined to be complete, however, then at 130 the winner of the game is announced, awards such as cash or prizes are distributed or arranged for, and the game is concluded. The game can be reinitialized at 110 as may be desired. It will be understood that some or all of the gaming features of the alternative embodiments described above with reference to the first exemplary system 10 can be incorporated into the gaming method 100.

Referring now to FIG. 3, there is shown one possible display of the outcome choices 22 and payout odds 27 to the players on their user interfaces, and one possible sequence of such displays resulting from playing the game according to the system and/or method described herein. It will be understood that this one possible display and number and sequence of actual outcomes is shown to illustrate the advantages of the invention, and is not intended to limit in any way the possible display formats or actual outcomes that can be accommodated by the invention.

As shown in display 150, the players are presented with three outcome choices and the associated payout odds. In this case, these are a “pass for a first down” at “3:2” payout odds, a “run for seven or more yards” at “2:2” payout odds, and a “quarterback sack” at “2:2” payout odds. At this stage in the game, this player's score is 500 and the game situation is Denver's ball, first and ten-to-go, on Los Angeles' forty-yard-line, with Denver trailing fourteen to six.

The player then predicts that Denver will run for seven or more yards, and enters a wager amount of 20 on this outcome. The actual outcome is a run for an eight-yard gain, so the players predicted outcome was correct. Based on the payout odds for this outcome of 2:1, the player is credited with 40 points, and his score is updated to 540.

At display 152, the players are presented with three new outcome choices and the associated payout odds for them. Because the game situation has changed, that is, it is now second-and-two on the thirty-two yard-line, the outcome choices and payout odds are also changed. In this game situation, sometimes the offense will throw a long pass knowing that even if it is unsuccessful, they can still have another play on third down to make the first down. So now the outcome choices are a “pass for a touchdown” at “5:1” payout odds, a “quarterback sack” at “3:1” payout odds, and a “run for a first down” at “2:1” payout odds.

The player then predicts that Denver will pass for a touchdown, and enters a wager amount of 30 on this outcome. The actual outcome turns out to be an incomplete pass, so the player's predicted outcome was incorrect. Based on the amount wagered for this outcome, the player is debited by 30 points, and his score is updated to 510.

Then as shown in display 154, the players are presented with three new outcome choices and the associated payout odds for them. Again, the game situation has changed, so that now it is third-and-two on the thirty-two yard-line. Accordingly, the outcome choices and payout odds are also changed. Now the outcome choices are a “fumble” at “9:1” payout odds, a “run for less than a first down” at “2:1” payout odds, and a “run for a first down” at “1:1” payout odds.

The player then predicts that Denver will run for a first down, and enters a wager amount of 100 on this outcome. In a third-and-short game situation, this would seem a high likelihood outcome, so the payout odds are relatively low. The actual outcome is a run for a one-yard gain, so again the player's predicted outcome was incorrect. Based on the amount wagered for this outcome, the player is debited by 100 points, and his score is updated to 410.

Then in display 156, the players are again presented with three new outcome choices and the associated payout odds for them. Of course, the game situation has once again changed, so that now it is fourth-and-one on the thirty-one yard-line. Conventional wisdom might suggest kicking a field goal, so the payout odds for a “made field goal” and a “missed field goal” are relatively low at “1:1” payout odds. But to provide for enhanced participant entertainment, the third outcome choice is designated as “fake field goal for a touchdown” at “20:1” payout odds.

The player then predicts that Denver will fake the field goal and score a touchdown on the play, and enters a wager amount of 20 on this outcome. As it turns out, this is the actual outcome, so the player's predicted outcome was correct. Based on the amount wagered for this outcome, the player is credited with 400 points, and his score is updated to 810. Also, the score of the underlying game is updated to reflect the scoring, thereby showing the game score as Denver twelve to Los Angeles fourteen.

Now as shown in display 158, after the touchdown, the players are presented with three new outcome choices and the associated payout odds for them. Accordingly, the outcome choices and payout odds are changed to reflect the relevant special teams outcome choices of a “blocked point-after-touchdown” at “10:1” payout odds, a “made two-point conversion” at “2:1” payout odds, and a “missed point-after-touchdown” at “8:1” payout odds. The player then predicts and wagers on an outcome selected from one of these of these outcomes, and the process is repeated until a winner is determined.

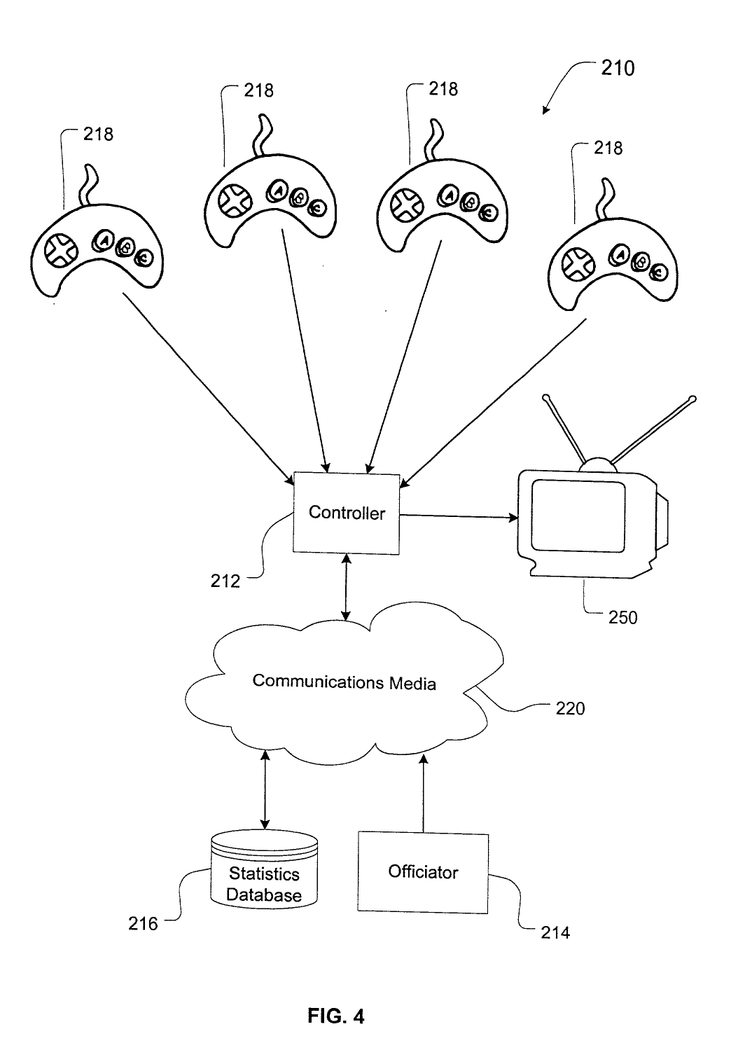

Referring now to FIG. 4, there is illustrated a second exemplary embodiment of the present invention, referred to generally as the system 200. Similar to the system 10 of the first embodiment, this system 200 comprises a controller 212 that communicates with an officiator 214, a database 216, and user interfaces 218. In this form of the invention, however, the controller 212 is local to the user interfaces 218. Thus, this system 200 can be used for playing the game at home, a sports bar, a restaurant, a casino, or elsewhere.

The controller 212 can communicate with the user interfaces 218 by wires, radio of optical wireless systems, or otherwise. The database 216 and the officiator 214 can be remote from the controller 212 and can communicate by a communications media 220 similar to that described above. Alternatively, the database 216 (and the officiator 214) can be local to the controller 212 and hardwired to the computer, with database updates sent over the Internet, by regular mail, or otherwise, if so desired.

In this embodiment, the user interfaces 218 can be provided by joysticks, keypads (with operative selection buttons), touch-screens, remote controls devices, or other input and/or output devices. Additionally, the game displays can be shown to and viewed by the players on a television or other output device 250, while the players enter their predicted outcomes via the user interfaces 218.

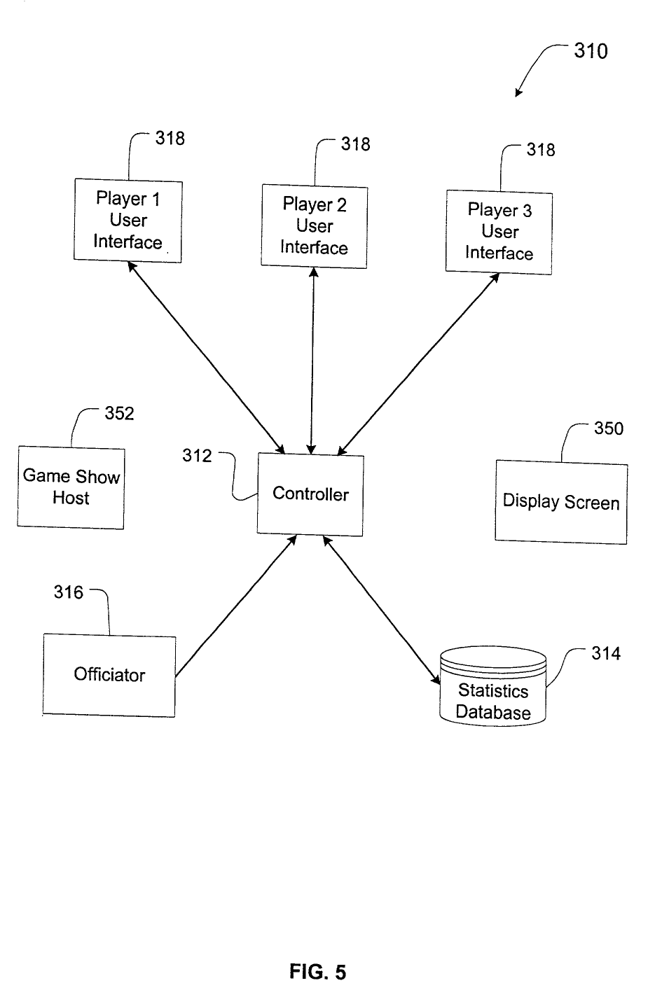

Referring now to FIG. 5, there is illustrated a third exemplary embodiment of the present invention, referred to generally as the system 300. Similar to the system 10 of the first embodiment, this system 300 comprises a controller 312 that communicates with an officiator 314, a database 316, and user interfaces 318. In this form of the invention, however, the controller 312 is local to the user interfaces 318, the officiator 314, and the database 316. Thus, this system 300 can be used for playing the game as a television game show.

In this embodiment, the user interfaces 318 can be provided by keypads on pedestals, touch-screens, remote controls devices, or other input and/or output devices. Also, the controller 312 can communicate with the user interfaces 318, the officiator 314, and the database 316 by wires, radio or optical wireless systems, a communications media similar to that describe above, or otherwise. Additionally, the game displays can be shown to and viewed by the players on a television, projection screen, or other output device 350, while the players enter their predicted outcomes via the user interfaces 318. Furthermore, the game can be directed by a game show host 352 who coordinates the show.

There are a number of alternative embodiments of this game show version. In one alternative embodiment, the players include game show contestants, audience members, real-life coaches and/or home players. This embodiment effectively combines the first and third embodiments, so that, for instance, a home or restaurant player can wager on whether a coach on the show will predict the correct outcome. In another embodiment, the players are the winners of a previous round of games, with each round of games progressing from local to state to regional to national levels.

Accordingly, the gaming system and method of the present invention provide for an enhanced spectator experience of sporting events. The real-time outcome choices and payout odds based on the changing game conditions provide a play-along feature that better engages the spectator in the flow of the game. Thus, the outcome choices can be selected to be especially relevant, realistic, and/or interesting given the current game situation. Also, the payout odds can be selected to provide entertaining twists to simply sitting back and watching conventional sporting events.

In the embodiments described above and the following claims, the use of a singular or plural form of a term is not intended to limit the term to that form, unless specified otherwise herein. For example, the words “a,” “an,” and “one” are not intended to mean “only one” but can also mean “more than one.” Also, the method steps described herein are not intended to be limited to the specific sequences described but can be carried out in other sequences, unless specified otherwise herein.

While the invention has been disclosed in exemplary forms, those skilled in the art will recognize that many modifications, additions, and deletions can be made therein without departing from the spirit and scope of the invention as set forth in the following claims.

What is claimed is:

1. A gaming system for use by one or more players using interface devices and apprehending an event having discrete segments, the system comprising:
a) a database having data retrievably stored therein;
b) an officiator input device for receiving actual outcomes of the event segments; and
c) a controller in communication with the database and the officiator input device, wherein the controller is programmed to query the database for data related to one of the event segments, receive the data from the database, send to the interface devices payout odds relating to the data, receive a predicted outcome and a wager amount from each of the interface devices, receive the actual outcome from the officiator input device, determine a credit or debit amount for each correct or incorrect predicted outcome, and apply the credit or debit amount to a player score.

2. The system of claim 1, wherein the data stored in the database includes probabilities of the actual outcomes occurring, and the controller is further programmed to determine the payout odds based on the probabilities.

3. The system of claim 2, wherein the controller is further programmed to adjust the payout odds by increasing or decreasing them.

4. The system of claim 1, wherein the data stored in the database includes non-probabilistic data, and the controller is further programmed to determine the probabilities of the actual outcomes occurring.

5. The system of claim 1, wherein the officiator input device is configured to receive outcome choices selected to be relevant to one or more of the event segments, and the controller is programmed to query the database for data related to the outcome choices.

6. A gaming system for use by one or more players using interface devices and apprehending an event having discrete segments, the system comprising:
a) an officiator input device for receiving actual outcomes of the event segments; and
b) a controller in communication with the officiator input device, wherein the controller is programmed to select or receive designated outcome choices for each event segment, match the outcome choices with predetermined payout odds, send to the interface devices the outcome choices and payout odds, receive a predicted outcome and a wager amount from each of the interface devices, receive the actual outcome from the officiator input device, determine a credit or debit amount for each correct or incorrect predicted outcome, and apply the credit or debit amount to a player score.

7. The system of claim 6, wherein the designated the outcome choices are selected to be relevant to one or more of the event segments.

8. The system of claim 7, wherein the designated outcome choices are received from the officiator input device or from the user interface devices.

9. The system of claim 6, wherein the predetermined payout odds are fixed or the controller is programmed to select them from a range of available payout odds.

10. The system of claim 6, wherein the controller is programmed to match the outcome choices with the payout odds based on historical data.

11. A gaming system for use by one or more players using interface devices and apprehending an event having discrete segments, the system comprising:
a) a database having data retrievably stored therein;
b) an officiator input device for receiving outcome choices for each event segment and actual outcomes of the event segments; and
c) a controller in communication with the database and the officiator input device, wherein the controller is programmed to receive the outcome choices from the officiator input device, query the database for data related to one of the outcome choices, receive the data from the database, send to the interface devices payout odds relating to the data, receive a predicted outcome and a wager amount from each of the interface devices, receive the actual outcome from the officiator input device, determine a credit or debit amount for each correct or incorrect predicted outcome, and apply the credit or debit amount to a player score.

12. The system of claim 11, wherein the data stored in the database includes probabilities of the actual outcomes occurring, and the controller is further programmed to determine the payout odds based on the probabilities.

13. The system of claim 12, wherein the controller is further programmed to adjust the payout odds by increasing or decreasing them.

14. The system of claim 11, wherein the officiator input device is configured to receive or select the outcome choices, and the outcome choices are selected to be relevant to one or more of the event segments.

15. The system of claim 11, wherein the outcome choices are selected to include a correct predicted outcome by another player, an incorrect predicted outcome by another player, or both.

16. The system of claim 11, wherein the controller is programmed to query the database for data relevant to the outcome choices of the next event segment, to the actual outcome of the preceding event segment, or to both.

17. The system of claim 11, wherein the controller is programmed to receive the predicted outcomes before, during, or after the completion of the event segment.

18. The system of claim 11, wherein the controller is programmed to query the database for trivia data in text or numerical form, send trivia questions to the user interface devices that are based on the trivia data, and receive predicted trivia answers from the user interface devices.

19. The system of claim 11, wherein the controller is programmed to update the database with the actual outcomes received from the officiator.

20. A gaming system for use by one or more players apprehending a sports event having discrete segments, the system comprising:
a) a plurality of interface devices for use by the players;
b) a database with sports data relating to the sports event segments retrievably stored therein;
d) an officiator input device for receiving outcome choices relevant to each sports event segment and actual outcomes of the sports event segments; and
e) a controller in communication with the interface devices, the database, and the officiator input device, wherein the controller is programmed to receive the outcome choices from the officiator input device, query the database for data related to the outcome choices, receive the data from the database, determine payout odds based on the data, send the payout odds to the interface devices, receive a predicted outcome and a wager amount from each of the interface devices, receive the actual outcome from the officiator input device, determine a credit or debit amount for each correct or incorrect predicted outcome, and apply the credit or debit amount to a player score.

21. The system of claim 20, wherein the database includes probabilities of the actual outcomes occurring, and the controller is further programmed to determine the payout odds based on the probabilities.

22. The system of claim 20, wherein the controller is programmed to determine and apply the credit or debit amount by comparing each predicted outcome to the actual outcome, and if the predicted outcome is incorrect then debiting the player score by the wager amount, or if the predicted outcome is correct then determining the credit amount by multiplying the wager amount by the payout odds and crediting the player score with the credit amount.

23. The system of claim 20, wherein the controller is disposed remote from the user interface devices and the database, remote from the user interface devices and local to the database, local to the user interface devices and remote from the database, or local to the user interface devices and the database.

24. The system of claim 11, wherein the system is embodied in a web site, home or restaurant game, or television show.

25. A method of gaming by one or more players apprehending a sports event having discrete segments, the method comprising:
a) initializing a player score;
b) designating outcome choices for one of the sports event segments;
c) retrieving or determining payout odds for the outcome choices;
d) displaying the outcome choices and the payout odds;
e) selecting a predicted outcome from the outcome choices;
f) wagering an amount on the predicted outcome;
g) determining an actual outcome of the play;
h) crediting or debiting the player score an amount based on whether the predicted outcome matches the actual outcome and on the payout odds; and
i) updating the player score.

26. The method of claim 25, wherein the step of determining the payout odds includes retrieving probabilities from a database and determining the payout odds based on the probabilities.

27. The method of claim 26, wherein the step of determining the payout odds further includes adjusting the payout odds by increasing or decreasing them.

28. The method of claim 25, wherein the step of designating the outcome choices includes selecting the outcome choices to be relevant to the next sports event segment, the preceding sports event segment, or both.

29. The method of claim 25, wherein the step of designating the outcome choices is performed by an officiator.

30. The method of claim 25, wherein the steps of selecting the predicted outcome and wagering the amount is performed by the players.

31. The method of claim 25, wherein the steps of initializing the player score, retrieving or determining the payout odds, crediting or debiting the player score, and updating the player score are performed by a controller.
